(19) United States
(12) Patent Application Publication
(10) Pub. No.: US 2018/0337791 A1
(43) Pub. Date: Nov. 22, 2018

(54) SIGNAL PROCESSING CIRCUIT AND METHOD

(71) Applicant: SONY CORPORATION, TOKYO (JP)

(72) Inventors: HIROAKI AMMO, KANAGAWA (JP); KEN SAWADA, KANAGAWA (JP)

(21) Appl. No.: 15/772,715

(22) PCT Filed: Nov. 2, 2016
(86) PCT No.: PCT/JP2016/082534

§ 371 Date: May 1, 2018

(30) Foreign Application Priority Data
Nov. 17, 2015 (JP) 2015-224694

(51) Int. Cl. H04L 9/32

(52) U.S. Cl. CPC H04L 9/3278

(57) ABSTRACT

The present disclosure relates to a signal processing circuit and method for the same capable of generating a stable physical unclonable function (PUF) being less susceptible to environmental changes and having less characteristic deterioration. Two VDDs are voltages alternately inverted. The two VDDs perform charge and discharge such that one is turned on while the other is turned off, and a current flows by a difference at an edge during switching (inversion). The output I1 is proportional to a capacitance value difference between the pair of DUTs, and the capacitance value difference between the pair of DUTs can be obtained by ΔC=ΔI/(VDD*f). The present technology is applicable to a signal processing circuit on which a differential pair is mounted, for example.

### TECHNICAL FIELD

The present disclosure relates to a signal processing circuit and a method for the same and more particularly relates to a signal processing circuit and a method for the same, capable of generating a stable physical unclonable function (PUF) being less susceptible to environmental changes and having less characteristic deterioration.

### BACKGROUND ART

In recent years, a physical unclonable function (PUF) is used in IC tags, authentication security systems, LSI counterfeit prevention, or the like. Examples of these are a smart card (non-patent document 1) using SRAM, and arbiter PUF.

In addition, a PUF technology (non-patent document 2) based on random telegraph noise (RTN) has been reported as not being commercialized.

Meanwhile, there is a proposed method of a difference charge-based capacitance measurement (DCBCM) method (refer to Patent Document 1 and Non-Patent Document 3) capable of detecting an extremely small capacitance difference of aF level.

### Citation List

### PATENT DOCUMENT

### [Patent Document 1] International Publication: WO 2013/091909

### Non-Patent Document

[Non-patent document 1] <Protecting next-generation Smart Card ICs with SRAM-based PUFs, Document order number: 9397 750 17366, www.nxp.com, February 2013>
[Non-Patent Document 2] <Jiezhi Chen, Tetsufumi Tanamoto, Hiroki Noguchi and Yuichiro Mitani, “Further Investigations on Traps Stabilities in Random Telegraph Signal Noise and the Application to a Novel Concept Physical Unclonable Function (PUF) with Robust Reliabilities”, Toshiba Corporation, VLSI Technology (VLSI Technology), 2015 Symposium on, T40-T41, 16-18 Jun. 2015>
[Non-Patent Document 3] <Ken Sawadal, Geert Van der Plas2, Yuichi Miyamori3, Tetsuya Oishi4,Cherman Vladimir2, Abdelkarim Mercha2, Verkest Diederik2, and Hiroaki Ammo41,“Characterization of Capacitance Mismatch Using Simple Difference Charge-Based Capacitance Measurement (DCBCM) Test Structure”, Sony Corporation to IMEC, Microelectronic Test Structures (ICMTS), 2013 IEEE International Conference on,49-52,25-28 Mar. 2013>

### SUMMARY OF THE INVENTION

### Problems to be Solved by the Invention

Unfortunately, however, an SRAM PUF needs to be turned OFF/ON at the time of PUF reading, while the arbiter PUF has output variation of the PUF due to environmental conditions such as a power supply voltage and temperature. In addition, RTN-based PUF utilizes traps on a gate oxide film and an interface, leading to characteristic deterioration at high temperatures. This need renew operation and lacks stability.

Accordingly, proposed is application of the DCBCM method of generating the PUF by using a capacitance highly resistant to environment changes.

The present disclosure has been made in view of such circumstances, and is intended to provide a technique capable of generating a stable PUF being less susceptible to environmental changes and having less characteristic deterioration.

### Solutions to Problems

A signal processing apparatus according to an aspect of the present technology includes a pair of capacitance forming a differential pair, and an output unit that detects a capacitance value difference between the pair of capacitance and outputs the difference to be applied to a physical unclonable function (PUF).

Further included is a voltage alternately inverted, and the capacitance value difference is detected by charging and discharging the pair of capacitance at the voltage.

The pair of capacitance is constituted by any two modules of capacitance of the capacitance array constituted by the capacitance arranged in a column, or in a matrix.

Further included is wire capacitance provided corresponding to the capacitance constituting the capacitance array, and the wire capacitance is corrected by using a plurality of voltages.

The pair of capacitance is gate capacitance or MIS type.

Further included is a switch arranged in parallel to the capacitance constituting the capacitance array, and the wire capacitance is corrected by turning on and off the switch.

The pair of capacitance is one of gate capacitance, MOM type wiring, and MIS type.

The output unit is capable of determining whether the capacitance value difference is positive or negative, converting the capacitance value difference into a 1-bit digital signal, and outputting the converted capacitance value difference.

The output unit can multivalue the capacitance value difference and output the processed capacitance value difference.

A signal processing method according to an aspect of the present technology includes detecting, by a signal processing circuit, a capacitance value difference of a pair of capacitance serving as a differential pair, and outputting the capacitance value difference to be applied to a physical unclonable function (PUF).

In one aspect of the present technology, a capacitance value difference of a pair of capacitance serving as a differential pair is detected and output to be applied to the physical unclonable function (PUF).

### Effects of the Invention

According to the present technology, it is possible to generate a stable physical unclonable function (PUF) being less susceptible to environmental changes and having less deterioration in characteristics.

Note that effects described here in the present specification are provided for purposes of exemplary illustration and effects of the present technology are not intended to be limited to the effects described in the present specification, and still other additional effects may also be contemplated.

### BRIEF DESCRIPTION OF DRAWINGS

FIG. 1 is a circuit diagram illustrating an exemplary configuration of a differential pair circuit according to the present technology.

FIG. 2 is a diagram illustrating a change timing of a voltage and a capacitance of the differential pair circuit in FIG. 1.

FIG. 3 is a circuit diagram illustrating another exemplary configuration of the differential pair circuit according to the present technology.

FIG. 4 is a circuit diagram illustrating still another exemplary configuration of the differential pair circuit according to the present technology.

FIG. 5 is a diagram illustrating a change timing of a voltage and a capacitance of the differential pair circuit in FIG. 4.

FIG. 6 is a diagram illustrating a graph for obtaining voltage dependency of AC.

FIG. 7 is a circuit diagram illustrating another exemplary configuration of the differential pair circuit according to the present technology.

FIG. 8 is a diagram illustrating a change timing of a voltage and a capacitance of the differential pair circuit in FIG. 7.

### MODE FOR CARRYING OUT THE INVENTION

Hereinafter, embodiments of the present disclosure (hereinafter, embodiment(s)) will be described.

<Example of Differential Pair Circuit of the Present Technology>

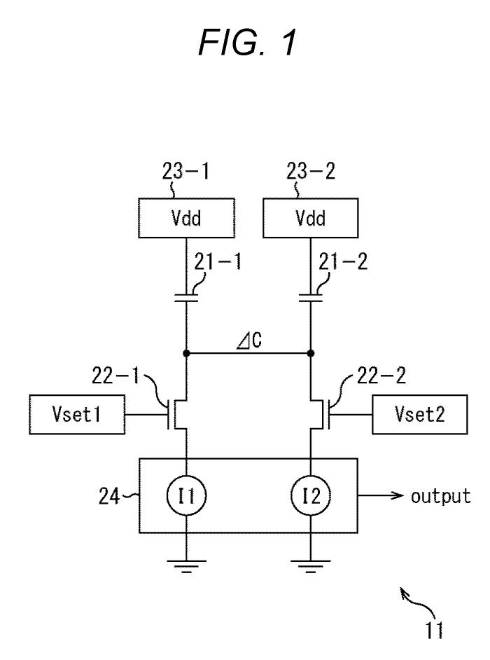

FIG. 1 is a circuit diagram illustrating an exemplary configuration of a differential pair circuit according to the present technology.

In the example of FIG. 1, a differential pair circuit 11 is a differential pair circuit including: DUT 21-1 and Tr 22-1 connected to VDD 23-1; DUT 21-2 and Tr 22-2 connected to VDD 23-2 arranged in pair with the VDD 23-1; and an output unit 24.

In the differential pair circuit 11, capacitance (MOS-C (gate capacitance), MIS-C (MIS type), Comb-C (MOM type wire), or the like) is arranged as DUT 21-1 and DUT 21-2. Tr 22-1 and Tr 22-2 are transistors, and pulses of Vset 1 and Vset 2 are applied to Tr 22-1 and Tr 22-2, respectively. VDD 23-1 and VDD 23-2 are power supply voltages. The output unit 24 outputs at least one of I1 and I2 to a subsequent stage (not illustrated).

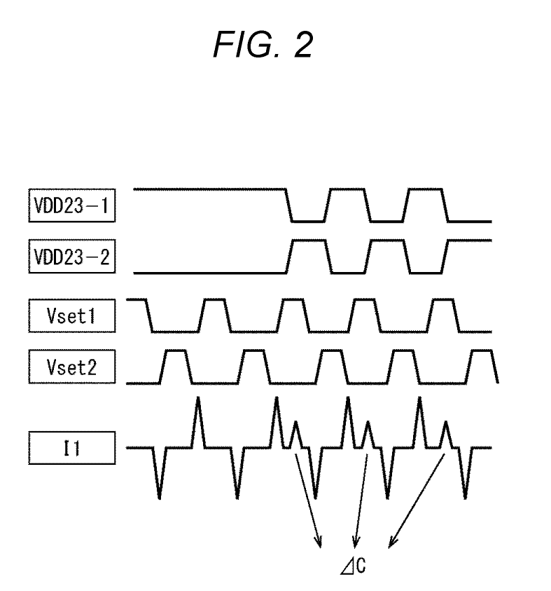

As illustrated in the timing chart of FIG. 2, pulses of VDD 23-1, VDD 23-2, Vset 1, and Vset 2 are applied. VDD 23-1 and VDD 23-2 are alternately inverted voltages. VDD 23-1 and VDD 23-2 perform charge and discharge such that one is turned on while the other is turned off, and a current flows by a difference at an edge during switching (inversion). The output I1 is proportional to the capacitance value difference between DUT 21-1 and DUT 21-2, and the capacitance value difference between DUT 21-1 and DUT 21-2 can be obtained by ΔC=ΔI/(VDD*f). Note that f is an input pulse frequency.

The capacitance value difference between DUT 21-1 and DUT 21-2 from the output unit 24 is applicable as 1-bit PUF with DUT 21-1>DUT 21-2 set to 0 and DUT 21-1<DUT 21-2 set to 1, and the number of differential pair circuits 11 in view of the security level is provided to form a PUF.

In addition, by allowing the differential pair to have redundancy, allowing the measurement result ΔC□0 to be a guard band, and avoiding the use of the differential pair being DUT 21-1≈DUT 21-2, it is possible to relax the measurement accuracy and enhance stability.

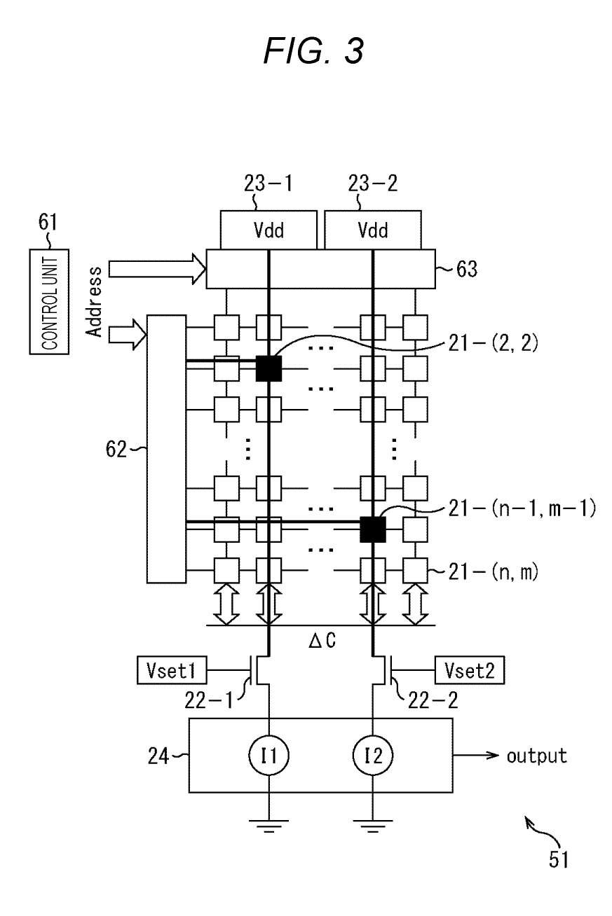

Moreover, in the case of the differential pair circuit 11 of FIG. 1, there is a need to form this differential pair circuit 11 in the number of bits of the PUF, resulting in decreased area efficiency. Therefore, a differential pair circuit having an arrayed DUT with enhanced area efficiency will be described with reference to FIG. 3.

<Example of Differential Pair Circuit of the Present Technology>

FIG. 3 is a circuit diagram illustrating another exemplary configuration of the differential pair circuit according to the present technology.

In the example of FIG. 3, a differential pair circuit 51 is similar to the differential pair circuit 11 in FIG. 1 in that it includes Tr 22-1 and Tr 22-2, VDD 23-1 and VDD 23-2, and the output unit 24. The differential pair circuit 51 is different from the differential pair circuit 11 in FIG. 1 in that DUT 21-1 and DUT 21-2 have been changed to arrayed DUTs 21-n and 21-m, and that it further includes a control unit 61, a Row decoder 62, and a Col decoder 63.

That is, the control unit 61 supplies two Row addresses for selecting the two DUTs 21-(n, m) to be output as I1 and I2 from n columns to the Row decoder 62. Moreover, the control unit 61 supplies two Col addresses for selecting the two DUTs 21-(n, m) to be output as I1 and I2 from m rows to the Col decoder 63.

The Row decoder 62 selects DUTs 21-(n, m) of the two Row addresses from the control unit 61. The Col decoder 63 selects DUTs 21-(n, m) of the two Col addresses from the control unit 61.

In the example of FIG. 3, DUT 21-(2, 2) selected by the Row decoder 62 and the Col decoder 63, and the transistor 22-1 are connected to the VDD 23-1. Moreover, DUT 21-(n-1, m-1) selected by the Row decoder 62 and the Col decoder 63, and the transistor 22-2 are connected to the VDD 23-2.

In this case, similarly to the example of FIG. 1, the pulses of VDD 23-1, VDD 23-2, Vset 1, and Vset 2 are applied. VDD 23-1 and VDD 23-2 perform charge and discharge such that one is turned on while the other is turned off, and a current flows by a difference at an edge during switching (inversion). The output I1 is proportional to the capacitance value difference between DUT 21-(2, 2) and DUT 21-(n-1, m-1), and the capacitance value difference between DUT 21-(2, 2) and DUT 21-(n-1, m-1) can be obtained from ΔC=ΔI/(VDD*f).

As described above, DUTs 21-(n, m) are arranged in an array, arbitrary two DUTs are selected by the Row decoder 62 and the Col decoder 63 and the magnitude comparison is performed by the differential pair circuit 51, leading to enhancement of the area efficiency.

While, one differential pair circuit 11 is not available in the case of DUT 21-1≈DUT 21-2 in the exemplary case of FIG. 1, for example, it suffices to change the combination of selections in the exemplary case of FIG. 3, leading to enhancement of the area efficiency without wasting the area.

Note that in a case where an increase in the array size produces a non-negligible amount of wire capacitance due to the difference in positions of two selected DUTs 21-(n, m) within the array, it is possible to pre-calculate wire capacitance values to be added for individual positions and to perform correction.

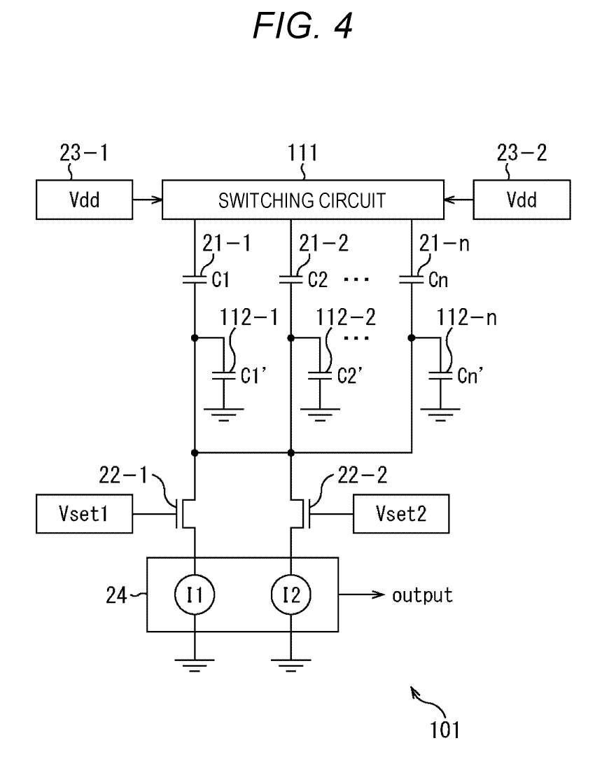

Even with such correction, however, it is difficult to eliminate the influence of intrinsic manufacturing variation in wire capacitance. Therefore, a differential pair circuit configured to eliminate the influence of variation in wire capacitance will be described with reference to FIG. 4.

<Example of Differential Pair Circuit of the Present Technology>

FIG. 4 is a circuit diagram illustrating another exemplary configuration of the differential pair circuit according to the present technology. Note that the example of FIG. 4 illustrates one row line DUT 21-1 to DUT 21-n for convenience of description, and omits illustration of DUT 21-1 to DUT 21-n for m-1 lines among the arrayed DUTs 21-(1, 1) to DUTs 21-(n, m), and the switching circuits for the row lines in FIG. 3. Therefore, in an actual differential pair circuit 101, DUT' 121-1 to DUT' 121-n are also constituted with DUT' 121-(1, 1) to DUT' 121-(n, m).

In the example of FIG. 4, the differential pair circuit 101 is similar to the differential pair circuit 11 in FIG. 1 in that it includes Tr 22-1 and Tr 22-2, VDD 23-1 and VDD 23-2, and the output unit 24. The differential pair circuit 101 is different from the differential pair circuit 11 in FIG. 1 in that DUT 21-1 and DUT 21-2 have been changed to arrayed DUT 21-1 to DUT 21-n as capacitance C1 to Cn, and that the circuit further includes a switching circuit 111, and DUT′ 121-1 to DUT′ 121-n as capacitance C1′ to Cn′ for wiring parasitic components.

Specifically, the switching circuit 111 connects the VDD 23-1, any one of DUT 21-1 to DUT 21-n, and Tr 22-1 while connecting VDD 23-2, any one of DUT 21-1 to DUT 21-n, and Tr 22-2. Moreover, the switching circuit 111 switches voltage connections, for example, connects VDD 23-2, any one of DUT 21-1 to DUT 21-n described above, and Tr 22-1 while connecting VDD 23-1, any one of DUT 21-1 to DUT 21-n described above, and Tr 22-2. In this manner, the switching circuit 111 connects each of DUT 21-1 to DUT 21-n to a plurality of voltages.

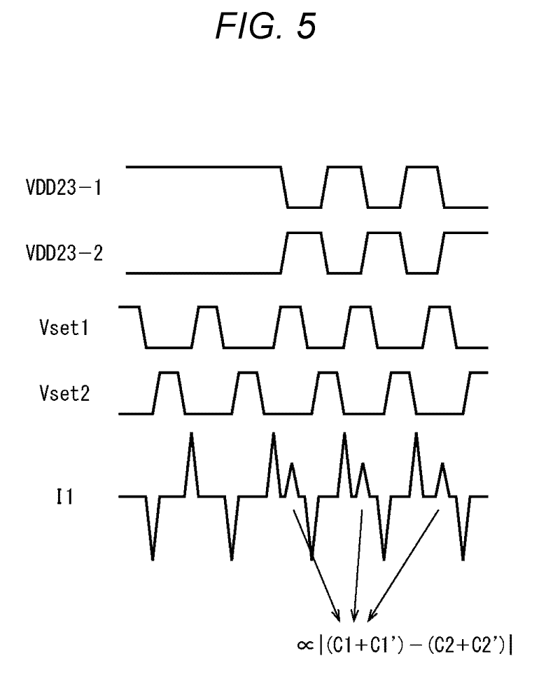

Note that, for the sake of convenience, for example, DUT 21-1 and DUT 21-2 will be used for explanation. After connection of DUT, as illustrated in FIG. 5, pulses of VDD 23-1, VDD 23-2, Vset 1, and Vset 2 are applied. VDD 23-1 and VDD 23-2 are alternately inverted voltages. VDD 23-1 and VDD 23-2 perform charge and discharge such that one is turned on while the other is turned off, and a current flows by a difference at an edge during switching (inversion). The output Il is proportional to a capacitance value difference {(C1+C1′)−(C2+C2′)} that is, the difference between the difference of DUT 21-1 and DUT′ 121-1 and the difference of DUT 21-2 and DUT′ 121-2.

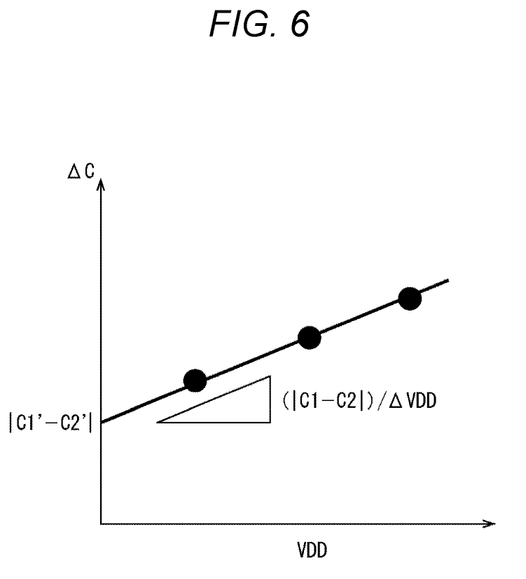

Here, as illustrated in FIG. 6, by determining the voltage dependency of AC, it is possible to separate the wire capacitance C1′ and C2′ having no voltage dependence. With this operation, it is possible to obtain the capacitance difference between DUT 21-1 and DUT 21-2.

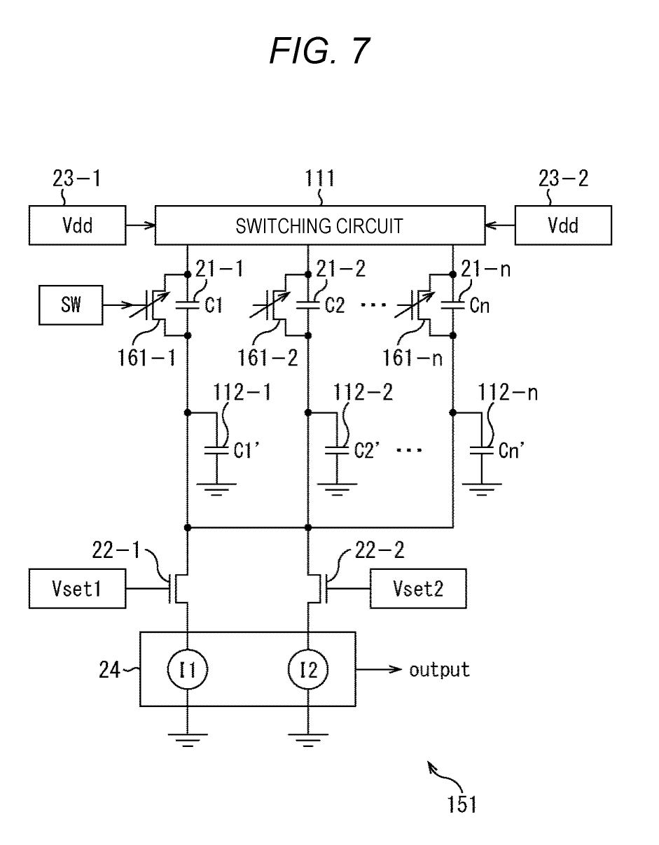

Note that the wire capacitance elimination method in FIG. 4 is not applicable in the case where DUT is a capacitance having no bias dependency such as Comb-C. Therefore, referring to FIG. 7, a differential pair circuit configured to eliminate the influence of variation in wire capacitance in a case where DUT is a capacitance having no bias dependency such as Comb-C.

<Example of Differential Pair Circuit of the Present Technology>

FIG. 7 is a circuit diagram illustrating another exemplary configuration of the differential pair circuit according to the present technology. Note that, similarly to the example in FIG. 4, the example in FIG. 7 illustrates one row line DUT 21-1 to DUT 21-n for convenience of description, and omits illustration of DUT 21-1 to DUT 21-n for m-1 lines among the arrayed DUT 21-(1, 1) to DUTs 21-(n, m), and the switching circuits for the row lines in FIG. 3. Therefore, in the actual differential pair circuit 151, DUT′ 121-1 to DUT′ 121-n are also constituted with DUT′ 121-(1, 1) to DUT′ 121-(n, m), and the switches 161-1 to switch 161-n are also constituted with switches 161-(1, 1) to 161-(n, m).

The differential pair circuit 151 in the example of FIG. 7 is similar to the differential pair circuit 101 in FIG. 4 in that the circuit includes: arrayed DUT 21-1 to DUT 21-n as C1 to Cn; Tr 22-1 and Tr 22-2; VDD 23-1 and VDD 23-2; the output unit 24; the switching circuit 111; and DUT′ 121-1 to DUT′ 121-n as the capacitance C1′ to Cn′ for wiring parasitic components. The differential pair circuit 151 is different from the differential pair circuit 101 in FIG. 4 in that the switches 161-1 to 161-n have been respectively added in parallel to the arrayed DUT 21-1 to 21-n as the capacitance C1 to Cn.

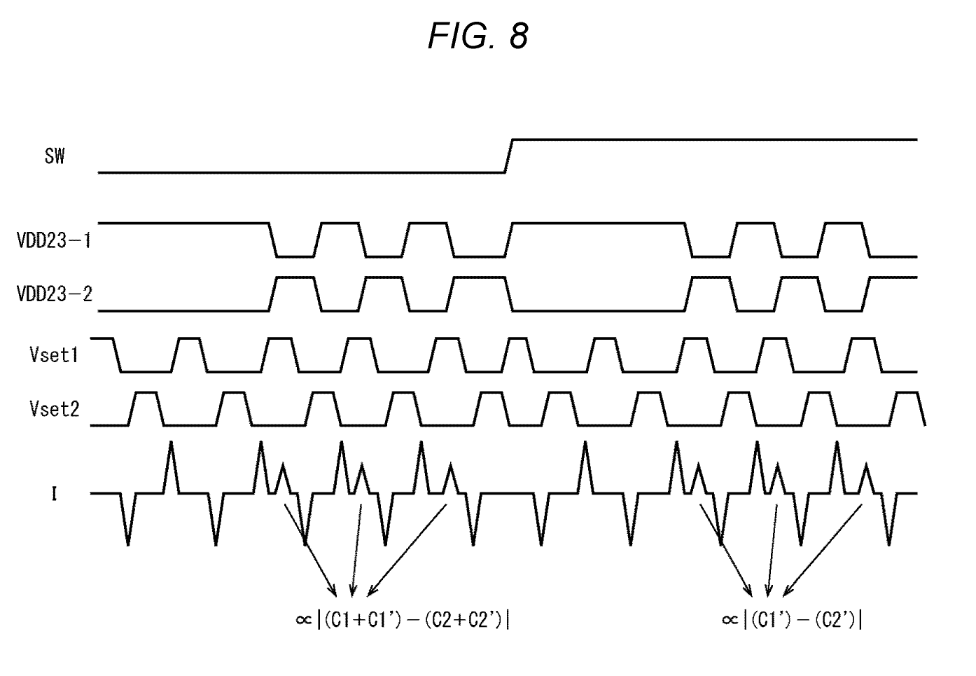

That is, similarly to the example in FIG. 4, the switching circuit 111 connects each of DUT 21-1 to DUT 21-n to a plurality of voltages. At that time, as illustrated in FIG. 8, by turning on and off the switches 161-1 to 161-n arranged in parallel, measurements are performed twice at the time of switch-on and switch-off. The measurement target at the time of switch-off is a difference value obtained from a sum of DUT capacitance and the wire capacitance, and the measurement target at the time of switch-on is a difference obtained from the wire capacitance alone. Therefore, the capacitance difference between DUT 21-1 and DUT 21-2 can be obtained by the both.

Note that, while the above describes an exemplary case where the PUF of 1 bit of 0 and 1 is generated depending on the magnitude of two DUTs, it is also allowable to multivalue the difference between the two DUTs, making it possible to enhance the area efficiency.

As described above, according to the present technology, it is possible to form a stable PUF being less susceptible to the influence of the environment or the like and having less deterioration in characteristics with relatively large area efficiency and low power consumption. Moreover, since the circuit of the present technology can be achieved by a standard process to be incorporated in a system-on-a-chip (SoC) or the like.

Note that embodiments of the present disclosure are not limited to the above-described embodiments but can be modified in a variety of ways within a scope of the present disclosure.

Alternatively, a configuration described above as a single apparatus (or processing unit) may be divided and configured as a plurality of apparatuses (or processing units). Conversely, a configuration described above as a plurality of devices (or processing units) may be collected and configured as a single device (or processing unit). In addition, configurations other than the above-described configurations may, of course, be added to the configurations of the apparatuses (or the processing units). Furthermore, as long as configurations or operation are substantially the same in the entire system, the configurations of certain apparatuses (or processing units) may be partially included in the configurations of the other apparatuses (or other processing units) Accordingly, the present technology are not limited to the above-described embodiments but can be modified in a variety of ways within a scope according to the present technology.

Hereinabove, the preferred embodiments of the present disclosure have been described above with reference to the accompanying drawings, while the present disclosure is not limited to the above examples. A person skilled in the art in the technical field of the present disclosure may find it understandable to reach various alterations and modifications within the technical scope of the appended claims, and it should be understood that they will naturally come within the technical scope of the present disclosure.

Note that the present technology may also be configured as follows.

(1) A signal processing circuit including:

a pair of capacitance forming a differential pair; and an output unit that detects a capacitance value difference

between the pair of capacitance and outputs the difference to be applied to a physical unclonable function (PUF).

(2) The signal processing circuit according to (1), further including a voltage alternately inverted,

in which the capacitance value difference is detected by charging and discharging the pair of capacitance at the voltage.

(3) The signal processing circuit according to (1) or (2),

in which the pair of capacitance is constituted by any two modules of capacitance of a capacitance array constituted with the capacitance arranged in a column, or in a matrix.

(4) The signal processing circuit according to (3), further including wire capacitance provided corresponding to the capacitance constituting the capacitance array,

in which the wire capacitance is corrected by using a plurality of voltages.

(5) The signal processing circuit according to (4),

in which the pair of capacitance is one of gate capacitance and MIS type.

(6) The signal processing circuit according to (3), further including a switch arranged in parallel to the capacitance constituting the capacitance array,

in which the wire capacitance is corrected by turning on and off the switch.

(7) The signal processing circuit according to any of (1) to (3) and (6),

in which the pair of capacitance is one of gate capacitance, MOM type wiring, and MIS type.

(8) The signal processing circuit according to any of (1) to (7),

in which the output unit determines whether the capacitance value difference is positive or negative, converts the capacitance value difference into a 1-bit digital signal, and outputs the converted capacitance value difference.

(9) The signal processing circuit according to any of (1) to (7),

in which the output unit multivalues the capacitance value difference and outputs the processed capacitance value difference.

(10) A signal processing method including

detecting, by a signal processing circuit, a capacitance value difference of a pair of capacitance serving as a differential pair and outputting the capacitance value difference to be applied to a physical unclonable function (PUF).

### REFERENCE SIGNS LIST

11 Differential pair circuit
21-1, 21-2, 21-3 to 21-n VDD
22-1, 22-2 Tr
23-1, 23-2 VDD
24 output unit
51 Differential pair circuit
61 Control unit
62 Row decoder
63 Col decoder
101 Differential pair circuit
111 Switching circuit
121-1 to 121-n DUT′
151 Differential pair circuit
161-1 to 161-n Switch

1. A signal processing circuit comprising:
a pair of capacitance forming a differential pair; and
an output unit that detects a capacitance value difference between the pair of capacitance and outputs the difference to be applied to a physical unclonable function (PUF).

2. The signal processing circuit according to claim 1, further comprising a voltage alternately inverted,
wherein the capacitance value difference is detected by charging and discharging the pair of capacitance at the voltage.

3. The signal processing circuit according to claim 2,
wherein the pair of capacitance is constituted by any two modules of capacitance of a capacitance array constituted with the capacitance arranged in a column, or in a matrix.

4. The signal processing circuit according to claim 3, further comprising wire capacitance provided corresponding to the capacitance constituting the capacitance array,
wherein the wire capacitance is corrected by using a plurality of voltages.

5. The signal processing circuit according to claim 4,
wherein the pair of capacitance is one of gate capacitance and MIS type.

6. The signal processing circuit according to claim 3, further comprising a switch arranged in parallel to the capacitance constituting the capacitance array,
wherein the wire capacitance is corrected by turning on and off the switch.

7. The signal processing circuit according to claim 1,
wherein the pair of capacitance is one of gate capacitance, MOM type wiring, and MIS type.

8. The signal processing circuit according to claim 1,
wherein the output unit determines whether the capacitance value difference is positive or negative, converts the capacitance value difference into a 1-bit digital signal, and outputs the converted capacitance value difference.

9. The signal processing circuit according to claim 1,
wherein the output unit multivalues the capacitance value difference and outputs the processed capacitance value difference.

10. A signal processing method comprising detecting, by a signal processing circuit, a capacitance value difference of a pair of capacitance serving as a differential pair and outputting the capacitance value difference to be applied to a physical unclonable function (PUF).
